(19) United States
(12) Patent Application Publication
(10) Pub. No.: US 2016/0277943 A1
(43) Pub. Date: Sep. 22, 2016

(54) NETWORK SYSTEM, CONTROL METHOD OF NETWORK SYSTEM, COMMUNICATION DEVICE, AND PROGRAM

(71) Applicant: Hitachi, Ltd., Tokyo (JP)

(72) Inventor: Takashi Isobe, Tokyo (JP)

(21) Appl. No.: 14/976,472

(22) Filed: Dec. 21, 2015

(30) Foreign Application Priority Data
Mar. 17, 2015 (JP) 2015-053093

(51) Int. Cl. H04W 24/02; H04L 12/26; H04L 29/08

(52) U.S. Cl. CPC H04W 24/02; H04L 67/10; H04L 43/08

(57) ABSTRACT

A network system has a plurality of communication devices, each of which controls communication between terminals connected through a network, and an analyzing device that analyzes a packet flowing through the network. The analyzing device includes an analyzing unit that analyzes a packet flowing through the network, and determines the necessity of a communication optimization function, for each communication, based on the analysis result, and a control unit that generates a control command of the communication device based on the determination result, and transmits the control command to the communication device. The communication device includes an optimization unit that performs an optimization process for the communication for which the communication optimization function is determined to be required, and a connection management unit that controls a transmission and reception process of the packet and changes the communication applied with the communication optimization function based on the control command.

### TECHNICAL FIELD

The present invention relates to a communication device that controls communication between terminals.

### BACKGROUND ART

A wide area network (WAN) using an internet protocol-virtual private network (IP-VPN) technique is generally used as an inter-site communication network used in such as a cloud computing.

When communication is intended to be performed between a terminal located at a certain site and a terminal located at a separate site, communication is performed through a line connecting a LAN at the certain site and a WAN and a line connecting the WAN and a LAN at the separate site. With respect to these lines, available bandwidths are determined based on contracted bandwidths.

TCP is generally used for communication between terminals. In TCP communication, with respect to data that a transmission-side terminal has transmitted, a reception-side terminal feeds back the position of received data to the transmission-side terminal. When the feed-back position of the received data is no longer changed, the transmission-side terminal determines this state as “discard detection”.

Furthermore, the transmission-side terminal manages a parameter called a congestion window size (a transmission-capable data size even if the reception terminal does not notify of reception), and changes the congestion window size depending on a round trip time (RTT) and the presence or absence of the discard detection.

For example, at the time of the discard detection or at the time of an increase in the RTT, the transmission-side terminal determines that a network is congested, and reduces the window size. This indirectly reduces the transmission bandwidth, thereby resulting in avoidance of the congestion of a network. At the time of the absence of the discard or at the time of a decrease in the RTT, the transmission-side terminal determines that a network is free and increases the window size. This indirectly increases the transmission bandwidth, thereby resulting in effective utilization of the line bandwidth of the network.

Since a TCP window size is less likely to be increased and a communication bandwidth is reduced in lines such as a WAN with a large RTT and a high discard rate, there is a problem that the utilization efficiency of a contract line is reduced. Further, since the costs of long-distance lines such as a WAN and a wireless line are high, the available bandwidth in a contract bandwidth is limited, and there is a problem that data transfer is not completed within a target time.

In order to solve the above problems, it is general to use a method of installing a communication device with a function of optimizing communication through a session at a relay point between two networks so as to effectively utilize a bandwidth. The afore-mentioned method is adapted to be used for a wireless terminal and a sensor terminal.

As a technique for optimizing the communication through a session, a technique of improving the bandwidth of TCP communication in a WAN (for example, PTL 1), a technique of reducing the amount of communication data between terminals (for example, PTL 2), and the like are known.

In PTL 1, disclosed is “a first communication device connected to a network, the first communication device including a bandwidth control unit that manages a bandwidth of a packet that is transmitted to a second communication device from the first communication device through the network at each interval, and changes a control bandwidth for transmitting a packet, on the basis of a retransmission bandwidth or a discard bandwidth of the managed current interval, and the control bandwidth of a previous interval, and a transmission unit that transmits the packet to the network in accordance with the control bandwidth”. Further, in PTL 2, disclosed are “a data compression system and a method, capable of detecting a repeated phrase of a variable length within a window of a size without limit and removing the phrase, on a computer”.

### CITATION LIST

### Patent Literature

PTL 1: Japanese Patent No. 5175982

PTL 2: US-A-2002-0037035

### SUMMARY OF INVENTION

### Technical Problem

The method of installing a communication device with a function of optimizing a communication session so as to effectively utilize a communication line bandwidth is used to satisfy needs for communication optimization of a large number of wireless terminals for radio carriers, and needs for effective information collection of a large number of sensor terminals for social infrastructures.

In order to satisfy the needs for radio carriers and social infrastructures, there is a problem that the multiple sessions need to be efficiently optimized. In order to solve this problem, the present invention provides a method, an apparatus, and a system, that effectively optimize only a communication session having a high optimizing effect with a small amount of resources during actual communication.

### Solution to Problem

A representative example of the invention disclosed in the present application is as follows. In other words, a network system includes a plurality of communication devices, each of which controls communication between terminals connected through a network, and an analyzing device that analyzes a packet flowing through the network, in which the analyzing device includes an analyzing unit that analyzes a packet flowing through the network, and determines the necessity of a communication optimization function that the communication device has, for each communication, based on the analysis result, and a control unit that generates a control command of the communication device based on the determination result, and transmits the control command to the communication device, in which the communication device includes an optimization unit that performs an optimization process for the communication for which the communication optimization function is determined to be required, and a connection management unit that controls a transmission and reception process of the packet and changes the communication applied with the communication optimization function based on the control command.

### Advantageous Effects of Invention

According to the present invention, it is possible to effectively utilize an optimization function of a communication device, in a network in which multiple communications are present. Problems, configurations and effects other than those described above will become apparent from the following description of examples.

### BRIEF DESCRIPTION OF DRAWINGS

FIG. 1 is an explanatory diagram illustrating a configuration example of a network system of Example 1.

FIG. 2 is a block diagram illustrating an example of a hardware configuration and a software configuration of a communication device of Example 1.

FIG. 3 is a block diagram illustrating an example of a hardware configuration and a software configuration of an analyzing device of Example 1.

FIG. 4 is an explanatory diagram illustrating a format of a packet that the communication device of Example 1 transmits and receives.

FIG. 5 is an explanatory diagram illustrating an example of a session management table included in the communication device of Example 1.

FIG. 6 is a block diagram illustrating a relationship between respective function units of the communication device, a transfer device, and the analyzing device of Example 1. The process of the function unit of each device will be described.

FIG. 7 is an explanatory diagram illustrating a data structure of session data of each session, which is stored in a communication information storage unit of Example 1.

FIG. 8 is an explanatory diagram illustrating a data structure of capture data, which is stored in the communication information storage unit of Example 1.

FIG. 9 illustrates a data structure of analysis data, which is stored in the communication information storage unit of Example 1.

FIG. 10 is a flowchart illustrating a process that is executed by a reception processing unit of the analyzing device of Example 1.

FIG. 11 is a flowchart illustrating a process that is executed by a communication information circulating unit of the analyzing device of Example 1.

FIG. 12 is a flowchart illustrating a process that is executed by the communication information circulating unit of the analyzing device of Example 1.

FIG. 13 is a flowchart illustrating a process that is executed when a connection management unit of the communication device of Example 1 receives a control command from the analyzing device.

FIG. 14A is a flowchart illustrating a process that is executed by the connection management unit of the communication device of Example 1.

FIG. 14B is a flowchart illustrating a process that is executed by the connection management unit of the communication device of Example 1.

FIG. 15 is an explanatory diagram illustrating state transition until the communication device of Example 1 starts an optimization process.

FIG. 16 is an explanatory diagram illustrating state transition until the communication device of Example 1 ends the optimization process.

FIG. 17 is an explanatory diagram illustrating a state of a session of a communication line of Example 1.

FIG. 18 is a sequence diagram illustrating a flow of an application method of an optimization function to a session in the related art.

FIG. 19 is an explanatory diagram illustrating an example of an applied state of the optimization function of a communication device in the related art.

### DESCRIPTION OF EMBODIMENTS

Hereinafter, examples of the present invention will be described with reference to the accompanying drawings. The common components in the respective drawings are denoted by the same reference numerals.

### EXAMPLE 1

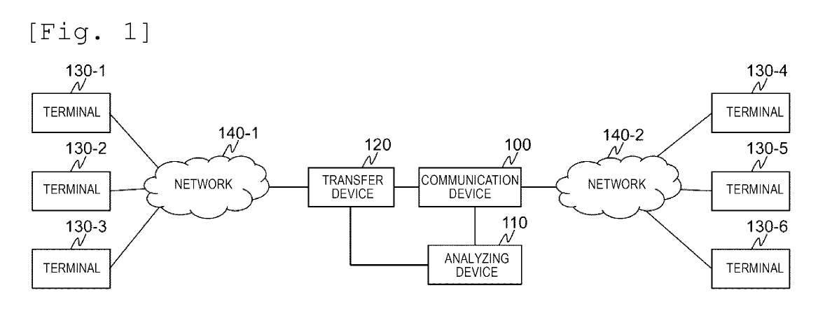

FIG. 1 is an explanatory diagram illustrating a configuration example of a network system of Example 1.

The network system of Example 1 includes a communication device 100, an analyzing device 110, a transfer device 120, and a plurality of terminals 130. In FIG. 1, a single device is illustrated respectively for the communication device 100, the analyzing device 110, and the transfer device 120, but two or more devices may be provided respectively.

A plurality of terminals 130-1, 130-2, and 130-3 and the transfer device 120 are connected with each other through a network 140-1. Further, a plurality of terminals 130-4, 130-5, and 130-6 and the communication device 100 are connected with each other through a network 140-2. A wide area network (WAN), a local area network (LAN), and the like are considered as the network 140. In addition, the type of the network 140 is not limited.

The terminal 130 communicates with other terminals 130, through the network 140, the communication device 100, and the transfer device 120.

The communication device 100 controls communication between the terminals 130. In the present example, it is assumed that the communication device 100 manages communication on a session basis. Further, in the present example, it is assumed that the session is a TCP session.

The communication device 100 performs a packet reception process and a packet transmission process. Further, the communication device 100 performs an optimization process on packets flowing through a certain session by using an optimization function. The communication device 100 enables or disables the optimization function for the session in response to the instruction from the analyzing device 110. The communication device 100 of the present example dynamically changes the session to be applied with the optimization function during communication through a session, based on the control command from the analyzing device 110.

The transfer device 120 transfers packets transmitted from the terminal 130 to the network 140-1 or the communication device 100. Further, the transfer device 120 of the present example transfers mirror packets passing through the communication device 100 and the transfer device 120, to the analyzing device 110.

The analyzing device 110 analyzes the mirror packets received from the transfer device 120, and determines the necessity of a specific function of the communication device 100 for each session based on the analysis result.

The analyzing device 110 transmits a control command to instruct enablement of the optimization function for the session for which the optimization function is determined to be needed, to the communication device 100. The analyzing device 110 can efficiently and effectively control the optimization function of the communication device 100 by managing and controlling communication for each TCP session.

The analyzing device 110 transmits a control command to instruct disablement of the optimization function for the session for which the optimization function is determined not to be needed, to the communication device 100. Thus, the communication device 100 applies the optimization function only to the packets flowing through the certain session, and transmits the packets flowing through the other sessions as they are.

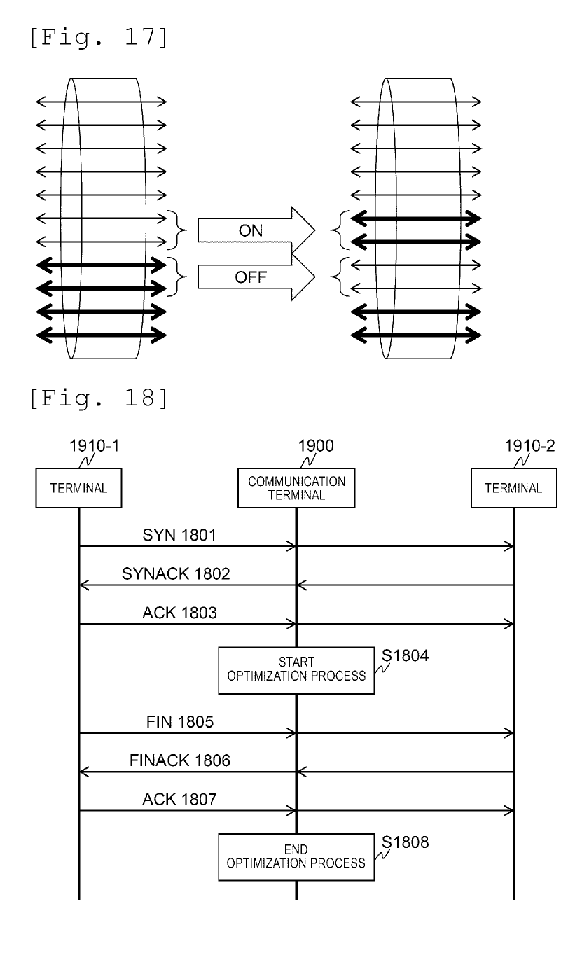

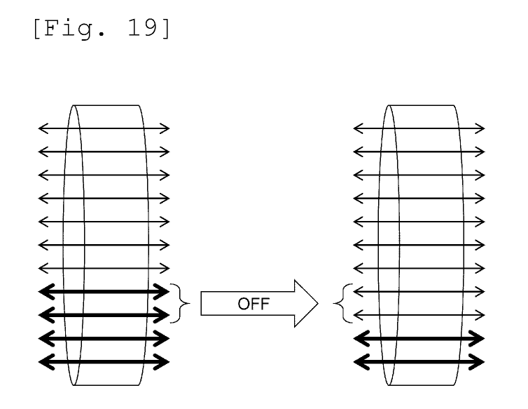

Here, an application method of an optimization function for a session in the related art will be described with reference to FIGS. 18 and 19.

FIG. 18 is a sequence diagram illustrating a flow of an application method of an optimization function for a session in the related art. FIG. 19 is an explanatory diagram illustrating an example of an applied state of the optimization function of a communication device in the related art.

In the related art, the optimization function is applied to the session, when the session is established. Specifically, a communication device 1900 transmits and receives a SYN packet 1801, a SYNACK packet 1802, and an ACK packet 1803 with a terminal 1910-1 and a terminal 1910-2, in a 3-Way Handshake, and activates the optimization function for the session, after the session has been established. In other words, an optimization process is started in the session (step S1804).

Further, in the related art, when the session is disconnected, the application of the optimization function to the session is finished. Specifically, the communication device 1900 transmits and receives a FIN 1805, a FINACK packet 1806, and an ACK packet 1807 with the terminal 1910-1 and the terminal 1910-2, and disables the optimization function for the session after the session has been disconnected. In other words, the optimization process is finished (step S1808).

In the related art, when the number of sessions exceeds the upper limit of the application of the optimization function when a session is established, the optimization function is not applied to the session.

FIG. 19 illustrates the states of sessions of the communication device 1900 in the related art. As illustrated in FIG. 19, the upper limit of the application of the optimization function of the communication device 1900 is “4”, the number of sessions applied with the optimization function is “4”, and the number of sessions that are not applied with the optimization function is “2”. In this case, in the related art when two sessions applied with the optimization function are disconnected, it is not possible to newly apply the optimization function to the session to which the optimization function is not applied, during communication through a session. Therefore, since it is not possible to optimize communication using the optimization function to the maximum extent, the communication resource of the communication device 1900 is wasted.

In the present example, in order to solve the problems described above, the analyzing device 110 dynamically selects a session with a high effect of the optimization function, and thus this enables communication using the communication resource of the communication device 100 to a maximum. Further, after receiving an instruction for enabling the optimization function, the communication device 100 enables the optimization function at a timing in which the reliability of communication can be secured.

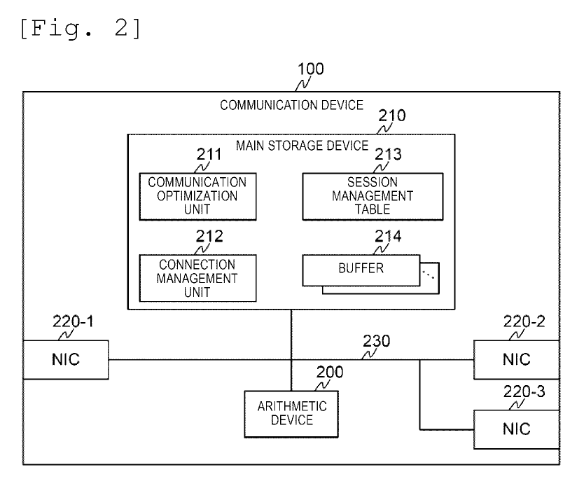

FIG. 2 is a block diagram illustrating an example of a hardware configuration and a software configuration of a communication device 100 of Example 1.

The communication device 100 includes an arithmetic device 200, a main storage device 210, and a plurality of NICs 220, as a hardware configuration. The arithmetic device 200, the main storage device 210, and the plurality of NICs 220 are connected with each other through a system bus 230.

The arithmetic device 200 executes programs that are stored in the main storage device 210. For example, a CPU, a GPU, and the like are considered as the arithmetic device 200. The functions of the communication device 100 are implemented by the arithmetic device 200 executing the programs. Hereinafter, the case where a description is made with a function unit as a subject indicates that the arithmetic device 200 executes the program for implementing the function unit.

The main storage device 210 stores programs that the arithmetic device 200 executes and information required to execute the programs. Further, the main storage device 210 includes a work area for each program to use, and a storage area such as a buffer 214.

The main storage device 210 of the present example stores programs for implementing a communication optimization unit 211 and a connection management unit 212. Further, the main storage device 210 stores a session management table 213.

The communication optimization unit 211 is a module that provides the optimization function, and performs the optimization process for a certain session. The optimization process includes a TCP acceleration process, a compression process, an application acceleration process, a difference transfer process, an encryption acceleration process, a cache process, and the like. In the present example, a TCP acceleration function that implements the TCP acceleration process will be referred to as an example of the optimization function.

The connection management unit 212 controls a packet transfer process (a transmission process and a reception process). Further, the connection management unit 212 dynamically changes a session to be applied with the optimization function, based on the control command transmitted from the analyzing device 110.

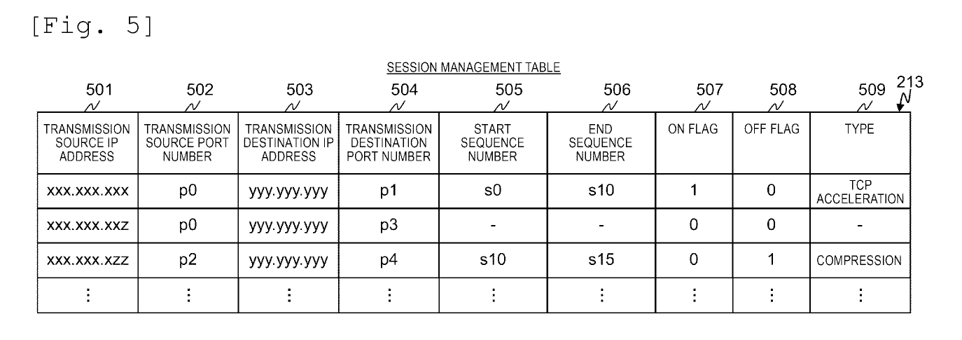

The session management table 213 stores information regarding a session of the communication device 100. The details of the session management table 213 will be described with reference to FIG. 5.

The buffer 214 is a storage area in which the packets received by the communication device 100 are temporarily stored. The size and the number of the buffer 214 can be appropriately changed.

The NIC 220 is an interface for connection with other devices. The communication device 100 of the present example includes three NICs 220-1, 220-2, and 220-3 which are respectively connected to the analyzing device 110, the transfer device 120, and the network 140-2.

In addition, the transfer device 120 is assumed to have the same hardware configuration as that of the communication device 100.

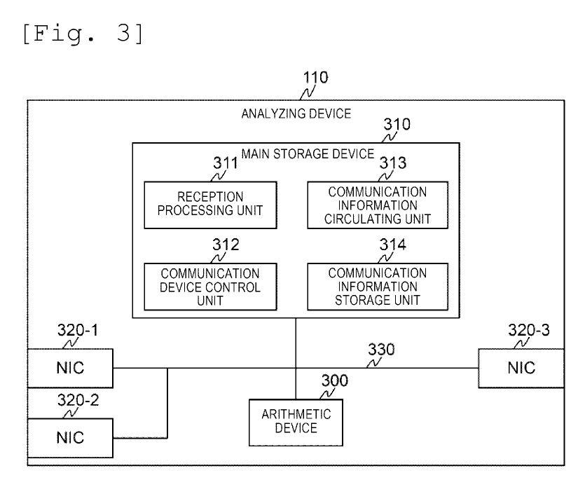

FIG. 3 is a block diagram illustrating an example of a hardware configuration and a software configuration of an analyzing device 110 of Example 1.

The analyzing device 110 includes an arithmetic device 300, a main storage device 310, and a plurality of NICs 320, as a hardware configuration. The arithmetic device 300, the main storage device 310, and the plurality of NICs 320 are connected with each other through a system bus 330.

The arithmetic device 300, the main storage device 310, and the NIC 320 are respectively the same as the arithmetic device 200, the main storage device 210, and the NIC 220.

The main storage device 310 stores programs for implementing a reception processing unit 311, a communication device control unit 312, a communication information circulating unit 313, and a communication information storage unit 314.

The reception processing unit 311 determines whether or not session information corresponding to a session through which a mirror packet is transferred is stored in the communication information storage unit 314, based on the header information of the mirror packet that is received from the transfer device 120.

When the information is stored in the communication information storage unit 314, the reception processing unit 311 analyzes the session information that is stored in the communication information storage unit 314 and the session information that is included in the header information of the mirror packet, and updates the session information that is stored in the communication information storage unit 314. When the session information on the session through which the mirror packet passes is not stored in the communication information storage unit 314, the reception processing unit 311 stores the session information on the session in the communication information storage unit 314.

The communication device control unit 312 transmits various control commands to the communication device 100, based on the session information of each session that is stored in the communication information storage unit 314.

Specifically, when it is determined that there is a need for an optimization function for any session, the communication device control unit 312 transmits a control command to instruct the enablement of the optimization function for the session, to the communication device 100. Meanwhile, when it is determined that there is no need for an optimization function for any session, the communication device control unit 312 transmits a control command to instruct disablement of the optimization function for the session, to the communication device 100.

The communication information circulating unit 313 checks the session information of each session that is stored in the communication information storage unit 314, determines the necessity of the optimization function for each session, and updates the session information containing the determination result.

The communication information storage unit 314 manages the session information of each session, and receives an update operation of the session information from the reception processing unit 311, the communication device control unit 312, and the communication information circulating unit 313 in parallel.

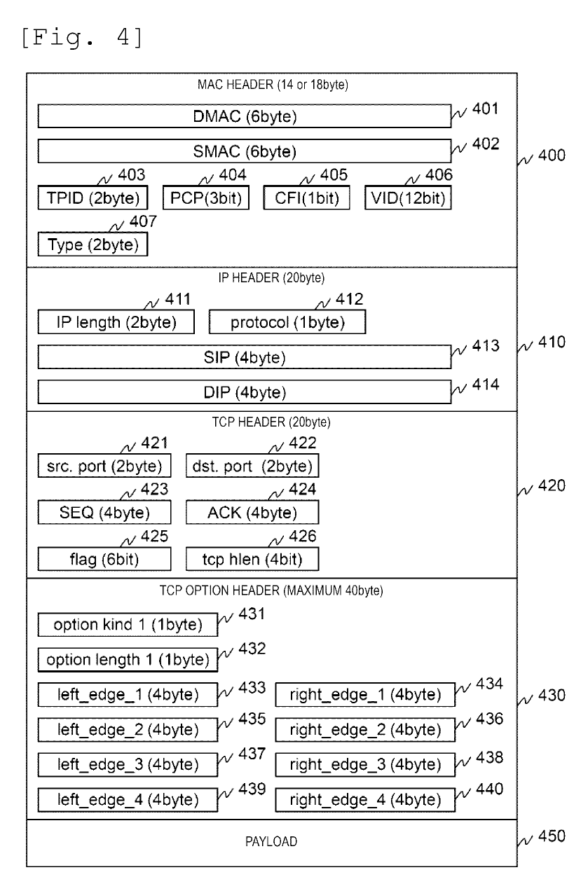

FIG. 4 is an explanatory diagram illustrating a format of a packet that the communication device 100 of Example 1 transmits and receives.

A packet includes a MAC header 400, an IP header 410, a TCP header 420, a TCP option header 430, and a payload 450.

The MAC header 400 includes a DMAC 401, an SMAC 402, a TPID 403, a PCP 404, a CFI 405, a VID 406, and a Type 407.

The DMAC 401 represents a destination MAC address. The SMAC 402 represents a transmission source MAC address. The Type 407 represents a MAC frame type.

The TPID 403 indicates that the frame type is VLAN. The PCP 404 represents the priority of the VLAN. CFI 405 represents whether or not the MAC address has a regular format. The VID 406 represents the ID number of the VLAN. In addition, in the communication without using the VLAN, the TPID 403 does not exist.

The IP header 410 includes IP length 411, protocol 412, SIP 413, and DIP 414.

The IP length 411 represents a packet length excluding the MAC header. The protocol 412 represents a protocol number. The SIP 413 represents a transmission source IP address. The DIP 414 represents a destination IP address.

The TCP header 420 includes src.port 421, dst.port 422, SEQ 423, ACK 424, flag 425, and tcp hlen 426.

The src.port 421 represents a transmission source port number. The dst.port 422 represents a destination port number. The SEQ 423 represents a transmission sequence number. The ACK 424 represents a received sequence number. The flag 425 represents a TCP flag number. The tcp hlen 426 represents the header length of the TCP.

The TCP option header 430 includes an option kind 1 (431), an option length 1 (432), left_edge_1to 4 (433, 435, 437, 439), and right_edge_1 to 4 (434, 436, 438, 440).

The option kind 1 (431) represents an option type. The option length 1 (432) represents an option length. The left_edge_1 to 4 (433, 435, 437, 439) and the right_edge_1 to (434, 436, 438, 440) are used to notify a transmission destination terminal 130 of the position of the data that is partially received, of one piece of data.

In addition, the left_edge_1 to 4 (433, 435, 437, 439) and the right_edge_1 to 4 (434, 436, 438, 440) may also be used for notification of the position of the data that cannot be partially received.

The TCP option header 430 may also be used for exchanging information between devices, when TCP communication is started.

For example, an MSS option is used for notifying an opposite device of the size of a receivable MSS of the communication device 100, when TCP communication is started. A SACK option is used not only for notifying the opposite device that the communication device 100 is compatible with the SACK option when TCP communication is started, but also for partially notifying the opposite device of the location of the received data when the discard of a packet is detected during communication. The time stamp option is used for notifying the opposite device of the reception time of the communication device 100 during communication. Thus, the TCP option header 430 is used to transmit the function and the information compatible with the communication device 100 to the opposite device, during the start of communication and during communication.

FIG. 5 is an explanatory diagram illustrating an example of a session management table 213 included in the communication device 100 of Example

The session management table 213 includes one entry per one session. The entry of the session management table 213 includes a transmission source IP address 501, a transmission source port number 502, a transmission destination IP address 503, a transmission destination port number 504, a start sequence number 505, an end sequence number 506, an ON flag 507, an OFF flag 508, and a type 509.

The transmission source IP address 501 and the transmission source port number 502 represent the IP address and the port number of the transmission source device (terminal 130). The transmission destination IP address 503 and the transmission destination port number 504 represent the IP address and the port number of the transmission destination device (terminal 130).

The start sequence number 505 represents the sequence number which is the top of a plurality of packets accumulated in the buffer 214. The end sequence number 506 represents the sequence number which is the end of the plurality of packets accumulated in the buffer 214.

The ON flag 507 is a flag instructing the enablement of the optimization function. “0” or “1” is stored in the ON flag 507. “0” is set as an initial value in the ON flag 507. When the control command to enable the optimization function is received by the analyzing device 110, “1” is set in the ON flag 507. Thus, a process enabling the optimization function is started. After the optimization function is enabled, in other words, the optimization process for a session is started, “0” is set again in the ON flag 507.

The OFF flag 508 is a flag indicating the disablement of the optimization function. “0” or “1” is stored in the OFF flag 508. “0” is set as an initial value in the OFF flag 508. When the control command to disable the optimization function is received by the analyzing device 110, “1” is set in the OFF flag 508. Thus, a process invalidating the optimization function is started. After the optimization function is invalidated, in other words, the optimization process for a session is ended, “0” is set again in the OFF flag 508.

The type 509 represents the type of the optimization function that is applied to a session.

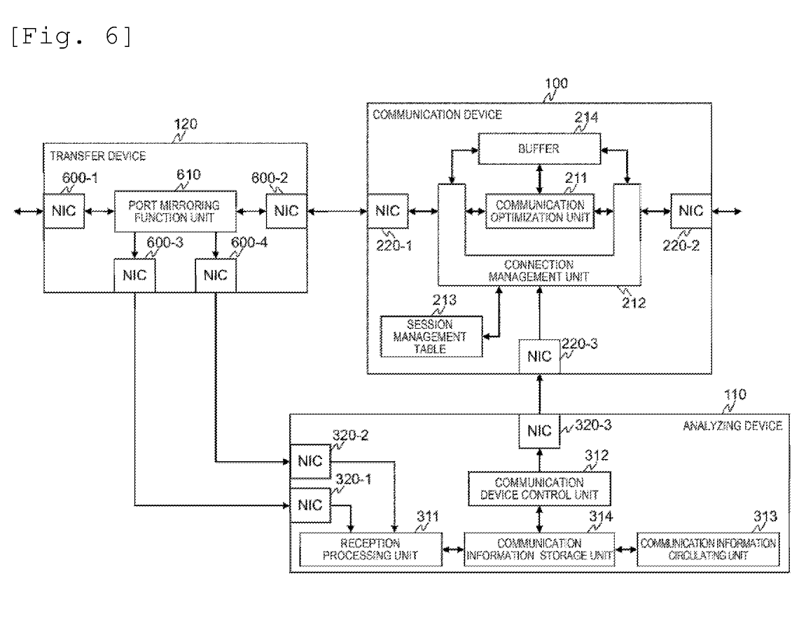

FIG. 6 is a block diagram illustrating a relationship between respective function units of the communication device 100, the transfer device 120, and the analyzing device 110 of Example 1. The process of the function unit of each device will be described.

(Transfer Device 120)

The transfer device 120 includes four NICs 600 and a port mirroring function unit 610. The port mirroring function unit 610 outputs a packet received from a NIC 600-1 to a NIC 600-2, and transmits the same mirror packet as the received packet, from a NIC 600-3 to the analyzing device 110. Further, the port mirroring function unit 610 outputs the packet received from the NIC 600-2, to the NIC 600-1, and transmits the same mirror packet as the received packet, from a NIC 600-4 to the analyzing device 110.

In the following description, the packet flowing from the network 140-1 to the network 140-2 is referred to as a right direction packet, and the mirror packet of the right direction packet is referred to as a right direction mirror packet. Further, the packet flowing from the network 140-2 to the network 140-1 is referred to as a left direction packet, and the mirror packet of the left direction packet is referred to as a left direction mirror packet. In addition, when the right direction mirror packet and the left direction mirror packet are not particularly distinguished, they are simply referred to as a mirror packet.

(Analyzing Device 110)

The reception processing unit 311 of the analyzing device 110 receives the right direction mirror packet through the NIC 320-1, and receives the left direction mirror packet through the NIC 320-2, from the transfer device 120. The reception processing unit 311 checks whether or not the session information on the session to which the mirror packet belongs is stored in the communication information storage unit 314, based on the header information of the received mirror packet.

When the above information is stored in the communication information storage unit 314, the reception processing unit 311 analyzes the session information stored in the communication information storage unit 314 and the session information of the header information of the mirror packet, and updates the session information to be stored in the communication information storage unit 314.

When the above information is not stored in the communication information storage unit 314, the reception processing unit 311 stores the session information on the session in the communication information storage unit 314.

The communication information circulating unit 313 checks the session information on each session stored in the communication information storage unit 314, determines the necessity of the optimization function of the communication device 100 for each session, and updates the session information including the determination result.

The communication device control unit 312 checks the session information on each session stored in the communication information storage unit 314. When it is determined that the optimization function is needed for any session, the communication device control unit 312 generates a control command to instruct the enablement of the optimization function for the session, and transmits the control command to the communication device 100 through the NIC 320-3. When it is determined that the optimization function is not needed for any session, the communication device control unit 312 generates a control command to instruct the disablement of the optimization function for the session, and transmits the control command to the communication device 100 through the NIC 320-3.

The communication information storage unit 314 receives an update operation of the session information from the reception processing unit 311, the communication device control unit 312, and the communication information circulating unit 313 in parallel.

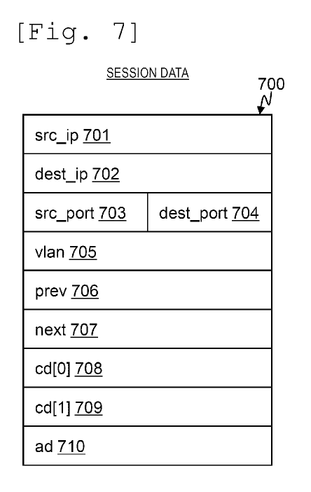

Here, the session information stored in the communication information storage unit 314 will be described with reference to FIGS. 7 to 9. The session information has data structures of three types of session data 700, capture data 800, and analysis data 900.

The session data 700 includes information for managing a session. The capture data 800 includes information on the mirror packet of a packet flowing for the session. In the present example, there are the capture data 800 of the right direction mirror packet and the capture data 800 of the left direction mirror packet. The analysis data 900 includes the analysis result of the mirror packet.

Two pieces of the capture data 800 and one piece of the analysis data 900 are associated and managed for one piece of the session data 700.

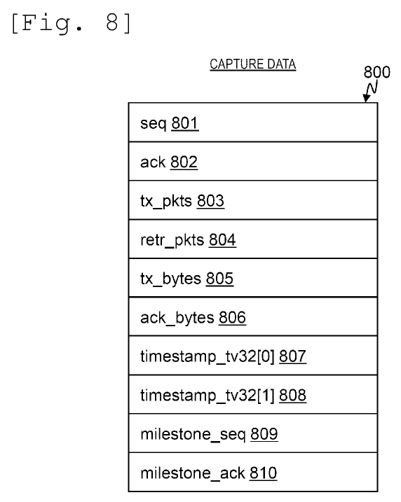

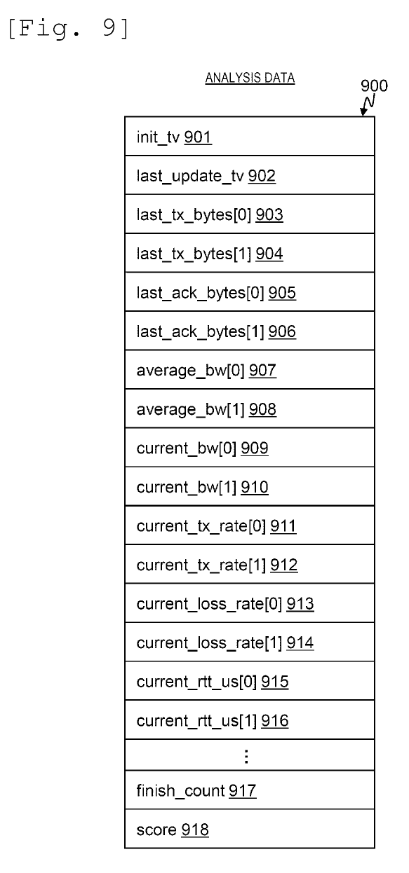

FIG. 7 is an explanatory diagram illustrating a data structure of the session data 700 of each session, which is stored in the communication information storage unit 314 of Example 1. FIG. 8 is an explanatory diagram illustrating a data structure of the capture data 800, which is stored in the communication information storage unit 314 of Example 1. FIG. 9 illustrates a data structure of the analysis data 900, which is stored in the communication information storage unit 314 of Example 1.

The session data 700 is information generated by the reception processing unit 311, and includes src_ip 701, dest_ip 702, src_port 703, dest_port 704, vlan 705, prey 706, next 707, cd[0] 708, cd[1] 709, and ad 710.

The src_ip 701 and the src_port 703 are the IP address and the port number of the transmission source device. The dest_ip 702 and dest_port 704 are the IP address and the port number of the transmission destination device. The vlan 705 is a vlan number.

The prey 706 and the next 707 are pointer variables for the session data 700. The cd[0] 608 and the cd[1] 609 are pointer variables for the capture data 800. The ad 710 is a pointer variable for the analysis data 900.

The capture data 800 is information that is generated and updated by the reception processing unit 311. The capture data 800 is present in each direction of a packet flowing through the transfer device 120. In other words, there are the capture data 800 of the right direction mirror packet and the capture data 800 of the left direction mirror packet.

The capture data 800 includes seq 801, ack 802, tx_pkts 803, retr_pkts 804, tx_bytes 805, ack_bytes 806, timestamp_tv32 [0] 807, timestamp_tv32 [1] 808, milestone_seq 809, and milestone_ack 810.

The seq 801 is the last number among the sequence numbers of the mirror packets that are received so far. The ack 802 is the last number among the ACK numbers of the mirror packets that are received so far.

The tx_pkts 803 is the number of mirror packets that are received so far. The retr_pkts 804 is the number of retransmission packets by TCP, among mirror packets that are received so far.

The tx_bytes 805 is the total value of the sizes of the payload of the mirror packets that are received so far. The ack_bytes 806 is the total value of the number of ACK-completed bytes of the mirror packets that are received so far.

The milestone_seq 809 is a marker sequence number used in the case of measuring a round-trip delay time between devices . The milestone_ack 810 is a marker ACK number used in the case of measuring a round-trip delay time between devices. Since the marker sequence number and the marker ACK number are denoted to be identical, it is possible to identify an ACK packet for a packet for which the marker sequence number is transmitted.

The timestamp_tv32[0] 807 is a time stamp of a first mirror packet when the seq 801 becomes larger than the milestone_seq 809. The timestamp_tv32[1] 808 is a time stamp of a first mirror packet when the ack 802 becomes larger than the milestone_ack 810.

The analysis data 900 is session information that is generated by the reception processing unit 311, and is updated by the communication information circulating unit 313. The analysis data 900 includes init_tv 901, last_update_tv 902, last_tx_byte[0] 903, last_tx_byte [1] 904, last_ack_bytes [0] 905, last_ack_bytes [1] 906, average_bw [0] 907, average_bw [1] 908, current_bw [0] 909, current_bw [1] 910, current_tx_rate [0] 911, current_tx_rate [1] 912, current_loss₁₃ rate [0] 913, current_loss_rate [1] 914, current_rtt_us [0] 915, current_rtt_us [1] 916, finish_count 917, and score 918.

The init_tv 901 is a time stamp of the mirror packet that is first received in the session. The last_update_tv 902 is a time when the communication information circulating unit 313 updates the session information in the previous time.

The last_tx_byte [0] 903 is the total value of the payload sizes of the received right direction mirror packets by the time the communication information circulating unit 313 updates the session information in the previous time. The last_tx_byte [1] 904 is the total value of the payload sizes of the received left direction mirror packets until the communication information circulating unit 313 updates the session information in the previous time.

The last_ack_bytes [0] 905 is the total value of the numbers of ACK-completed bytes by the received right direction mirror packets until the communication information circulating unit 313 updates the session information in the previous time. The last_ack_bytes [1] 906 is the total value of the numbers of ACK-completed bytes by the received left direction mirror packets until the communication information circulating unit 313 updates the session information in the previous time.

The average_bw [0] 907 is the average value of the communication speed of the right direction packet up to the current time after the init_tv 901. The average_bw [1] 908 is the average value of the communication speed of the left direction packet up to the current time after the init_tv 901.

The current_bw [0] 909 is the average value of the communication speed of the right direction packet up to the current time after the communication information circulating unit 313 updates the session information in the previous time. The current_bw [1] 910 is the average value of the communication speed of the left direction packet up to the current time after the communication information circulating unit 313 updates the session information in the previous time.

The current_tx_rate [0] 911 is a speed of the right direction packet including a retransmission packet up to the current time after the communication information circulating unit 313 updates the session information in the previous time. The current_tx_rate [1] 912 is a speed of the left direction packet including a retransmission packet up to the current time after the communication information circulating unit 313 updates the session information in the previous time.

The current_loss_rate [0] 913 is a retransmission rate of the right direction packet. The current_loss_rate [1] 914 is a retransmission rate of the left direction packet.

The current_rtt_us [0] 915 is a round-trip delay time in units of microseconds between the terminal 130 on the network 140-2 side and the communication device 100. The current_rtt_us [1] 916 is a round-trip delay time in units of microseconds between the terminal 130 on the network 140-1 side and the communication device 100.

The finish_count 917 is a flag variable that is used to determine whether or not a session has ended. When the FIN packet is received, the value of the finish_count 817 changes. The session information on the ended session is deleted by the communication information circulating unit 313. Further, the communication information circulating unit 313 deletes the session information that has not been updated for a predetermined amount of time.

The score 918 is a score used to determine the necessity of the optimization function of the communication device 100. In addition, the score 918 exists for each type of the optimization function, in the analysis data 900. In the present example, since a description is made focusing on the TCP acceleration as the optimization function, it is assumed that the score 918 for determining the necessity of the TCP acceleration is included in the analysis data 900.

The above is the description of the information that is stored in the communication information storage unit 314. A description will be made again with reference to FIG. 6.

(Communication Device 100)

When a packet is received through the NIC 220-1, the connection management unit 212 determines whether or not a session is a session to be applied with the optimization function, with reference to the session management table 213. For example, the connection management unit 212 considers a method of holding information on a session applied with the optimization function. In this case, the connection management unit 212 specifies a session based on the header information of a packet, and checks whether or not the optimization function is applied to the session.

When the received packet is a packet of a session applied with the optimization function, the connection management unit 212 outputs the packet to the communication optimization unit 211. When the received packet is not a packet of a session applied with the optimization function, the connection management unit 212 transmits the packet to the transfer device 120 through the NIC 220-2.

A similar process is performed also when a packet is received through a NIC 220-2.

When a control command to instruct the enablement of the optimization function for any session or a control command to instruct the disablement of the optimization function for any session is received through the NIC 220-3, the connection management unit 212 updates the session management table 213.

The communication optimization unit 211 performs an optimization process corresponding to the optimization function that has been applied to any session. For example, when a packet received from the NIC 220-2 is input, the communication optimization unit 211 that performs a TCP acceleration process ends the TCP communication of the received packet, and provides a proxy function of outputting the packet to the NIC 220-1 based on the TCP communication executing a faster congestion control algorithm. Further, when a packet received from the NIC 220-1 is input, the communication optimization unit 211 that performs a TCP acceleration process ends the TCP communication of the received packet, and outputs the packet to the NIC 220-2 based on the TCP communication executing an algorithm known as RENO.

In the present example, the connection management unit 212 has a function as a filter, but a separate filter may be provided. In this case, the connection management unit 212 performs the setting for the filter.

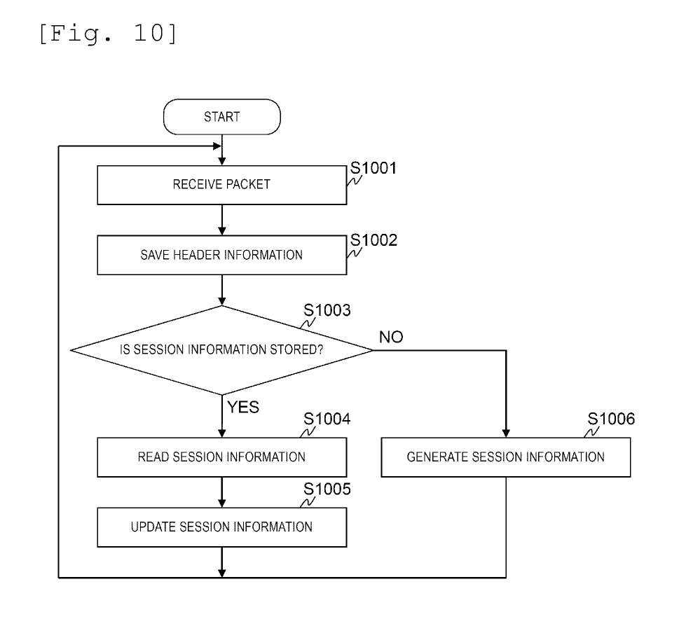

Then, the details of processes that the analyzing device 110 and the communication device 100 perform will be described. First, the process that the analyzing device 110 performs will be described with reference to FIGS. 10 to 12.

FIG. 10 is a flowchart illustrating a process that is executed by a reception processing unit 311 of the analyzing device 110 of Example 1.

When a mirror packet is received (step S1001), the reception processing unit 311 starts a process. First, the reception processing unit 311 stores the header information of the received mirror packet in the main storage device 310 (step S1002). The use amount of the storage area of the main storage device 310 is saved by storing only the header information of the mirror packet in the main storage device 310, and it is possible to improve the processing performance.

Then, the reception processing unit 311 determines whether or not the communication information storage unit 314 stores session information on the session to which the received mirror packet belongs (step S1003). Specifically, the reception processing unit 311 finds session information on the session, to which the received mirror packet belongs, from the session information that is stored in the communication information storage unit 314.

In the case of a mirror packet received from the NIC 320-1, the reception processing unit 311 finds an entry in which the SIP 413 matches the src_ip 701, the DIP 414 matches the dest_ip 702, the src.port 421 matches the srcport 703, the dst .port 422 matches the dest_port 704, and the VID 406 matches the vlan 705 . In the case of a mirror packet received from the NIC 320-2, the reception processing unit 311 finds an entry in which the SIP 413 matches the dest_ip 702, the DIP 414 matches the src_ip701, the src.port 421 matches the dest_port 704, the dst.port 422 matches the src_port 703, the VID 406 matches the vlan 705.

When it is determined that the communication information storage unit 314 stores the session information on the session to which the received mirror packet belongs, the reception processing unit 311 reads the session information (step S1004), and updates the session information based on the received mirror packet (step S1005). Thereafter, the reception processing unit 311 returns to step S1001 and performs the same process. In step S1005, for example, the following process is performed.

The reception processing unit 311 adds “1” to the tx_pkts 803 of the capture data 800. When the SEQ 423 is greater than the seq 801, the reception processing unit 311 adds a difference between the SEQ 423 and the seq 801 to the tx_bytes 805, and updates the seq 801 and the timestamp_tv32 [0] 807.

When the ACK 424 is greater than the ack 802, the reception processing unit 311 adds a difference between the ACK 424 and the ack 802 to the ack_bytes 806, and updates the ack 802 and the timestamp_tv32 [1] 808.

When the SEQ 423 is smaller than the seq 801 or the SEQ 423 is equal to the seq 801, and the payload length is “0”, the reception processing unit 311 adds “1” to the retr_pkts 804.

When it is determined that the communication information storage unit 314 does not store the session information on the session to which the received mirror packet belongs, the reception processing unit 311 generates new session information, and stores the generated session information in the communication information storage unit 314 (step S1006). Here, session information including one piece of session data 700, two pieces of capture data 800, and one piece of analysis data 900 is generated. Thereafter, the reception processing unit 311 returns to step S1001 and performs the same process. In step S1006, for example, the following process is performed.

The reception processing unit 311 sets the time stamp of the received mirror packet in the timestamp_tv32 [0] 807 and the timestamptv32[1] 808. The reception processing unit 311 sets “1” in the txpkts 803. The reception processing unit 311 sets the payload length in the tx_bytes 805, sets the value of the SEQ 423 in the seq 801, and sets the value of the ACK 424 in the ack 802.

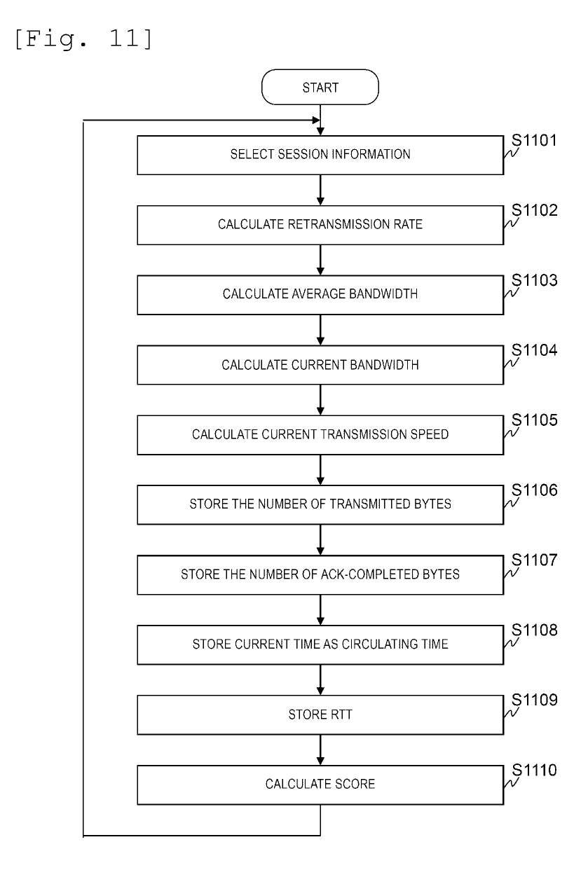

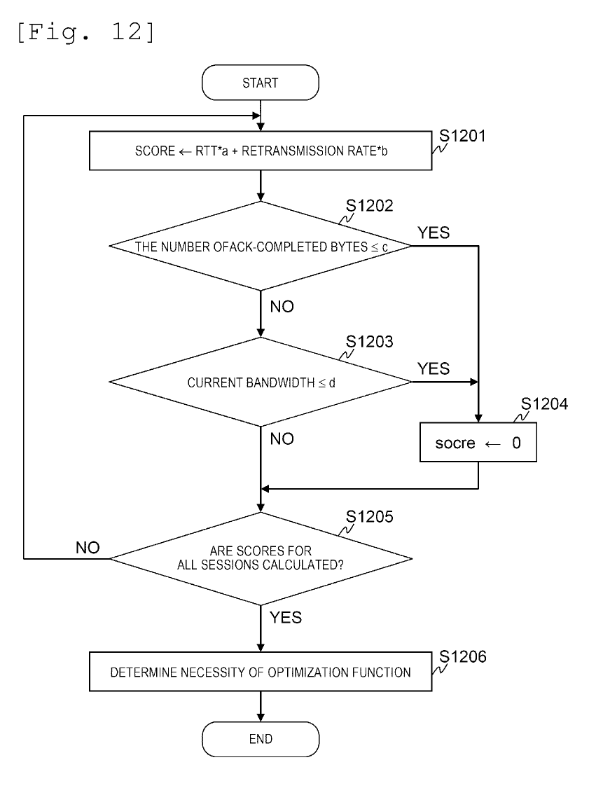

FIGS. 11 and 12 are flowcharts illustrating a process that is executed by the communication information circulating unit 313 of the analyzing device 110 of Example 1.

When an instruction is received periodically or from an operator, or the like, the communication information circulating unit 313 starts the process described below. In the following description, executing the process illustrated in FIG. 11 is also referred to as circulation of the session information.

The communication information circulating unit 313 selects target session information from among the session information pieces stored in the communication information storage unit 314 (step S1101). The present example is not dependent on the selection order of the session information.

In addition, when the process has been completed on all pieces of the session information, the communication information circulating unit 313 ends the process. Further, when any piece of session information is not stored in the communication information storage unit 314, the communication information circulating unit 313 ends the process. In this case, after the session information is stored, the process described below is performed.

The communication information circulating unit 313 calculates the retransmission rate of the packet based on the target session information (step S1102).

Specifically, the communication information circulating unit 313 calculates the retransmission rate of the right direction packet by substituting the tx_pkts 803 and the retr_pkts 804 of the capture data 800 corresponding to the right direction packet into the following Equation (1). Similarly, the communication information circulating unit 313 calculates the retransmission rate of the left direction packet by substituting the tx_pkts 803 and the retrpkts 804 of the capture data 800 corresponding to the left direction packet into Equation (1). The communication information circulating unit 313 sets the calculated retransmission rate of the right direction packet in current_loss_rate [0] 913 of the analysis data 900. Further, the communication information circulating unit 313 sets the calculated retransmission rate of the left direction packet in current_loss_rate [1] 914.

$$Transmission rate = \frac{retr\_pkts 804}{tx\_pkts 803} \qquad ( 1 )$$

Next, the communication information circulating unit 313 calculates the average bandwidth from the start of communication up to the current time, based on the target session information (step S1103).

Specifically, the communication information circulating unit 313 calculates the average bandwidth in the right direction by substituting the ack_bytes 806 of the capture data 800 corresponding to the right direction packet and the init_tv 901 of the analysis data 900 into the following Equation (2). Similarly, the communication information circulating unit 313 calculates the average bandwidth in the left direction by substituting the ack_bytes 806 of the capture data 800 corresponding to the left direction packet and the inittv 901 of the analysis data 900 into Equation (2). The communication information circulating unit 313 sets the calculated average bandwidth in the right direction in the average_bw [0] 907. Further, the communication information circulating unit 313 sets the calculated average bandwidth in the left direction in the average_bw[1] 908.

$$Average bandwidth = \frac{ack\_bytes 806}{( Present time - init\_tv 901 )} \qquad ( 2 )$$

Next, the communication information circulating unit 313 calculates the current bandwidth based on the target session information (step S1104).

Specifically, the communication information circulating unit 313 calculates the current bandwidth in the right direction by substituting the ack_bytes 806 of the capture data 800 corresponding to the right direction packet and the last_update_tv 902 of the analysis data 900 into the following Equation (3). The communication information circulating unit 313 calculates the current bandwidth in the left direction by substituting the ack_bytes 806 of the capture data 800 corresponding to the left direction packet and the last_update_tv 902 of the analysis data 900 into Equation (3). The communication information circulating unit 313 sets the calculated current bandwidth in the right direction in the current bw [0] 909 of the analysis data 900, and sets the calculated current bandwidth in the left direction in the current bw [1] 910.

$$Present bandwidth = \frac{ack\_bytes 806}{( Present time - last\_update \_tv 902 )} \qquad ( 3 )$$

Next, the communication information circulating unit 313 calculates the transmission speed up to the current time after the circulation of the session information in the previous time, based on the target session information (step S1105).

Specifically, the communication information circulating unit 313 calculates the present transmission speed in the right direction by substituting the tx_bytes 805 of the capture data 800 corresponding to the right direction packet and the last_update_tv 902 of the analysis data 900 into the following Equation (4). The communication information circulating unit 313 calculates the present transmission speed in the left direction by substituting the tx_bytes 805 of the capture data 800 corresponding to the left direction packet and the last_update_tv 902 of the analysis data 900 into Equation (4). The communication information circulating unit 313 sets the calculated present transmission speed in the right direction in the cument_tx_rate [0] 911 of the analysis data 900, and sets the calculated present transmission speed in the left direction in the currrent_tx_rate [1] 912.

$$Current transmission speed = \frac{tx\_bytes 805}{( Current time - last\_update \_tv 902 )} \qquad ( 4 )$$

Next, the communication information circulating unit 313 stores the number of transmitted bytes and the number of ACK-completed bytes in the session information (step S1106 and step S1107).

Specifically, the communication information circulating unit 313 stores the tx_bytes 805 of the capture data 800 corresponding to the right direction packet in the last_tx_bytes[0] 903 of the analysis data 900. Further, the ack_bytes 806 of the capture data 800 is stored in the last_ack_bytes [0] 905 of the analysis data 900. Further, the communication information circulating unit 313 stores the tx_bytes 805 of the capture data 800 corresponding to the left direction packet in the last_tx_bytes[1] 904 of the analysis data 900, and stores the ack_bytes 806 of the capture data 800 in the last_ack_bytes[1] 906 of the analysis data 900.

Next, the communication information circulating unit 313 stores the current time as the time of the circulation of the session information (step S1108).

Specifically, the communication information circulating unit 313 sets the current time in the last_update_tv 902 of the analysis data 900.

Next, the communication information circulating unit 313 calculates a round trip time (RTT) using the target session information (step S1109).

Specifically, the communication information circulating unit 313 calculates the RTT of communication in the right direction by substituting the timestamp_tv32 [1] 808 of the capture data 800 corresponding to the right direction packet and the timestamp_tv32 [0] 807 of the capture data 800 corresponding to the left direction packet into the following Equation (5). Further, the communication information circulating unit 313 calculates the RTT of communication in the left direction by substituting the timestamp_tv32 [1] 808 of the capture data 800 corresponding to the left direction packet and the timestamp_tv32 [0] 807 of the capture data 800 corresponding to the right direction packet into Equation (5). The communication information circulating unit 313 sets the calculated RTT of the communication in the right direction in the current_rtt_us [0] 915 of the analysis data 900, and sets the calculated RTT of the communication in the left direction in the current_rtt_us [1] 916.

RTT=timestamp_tv32[1]808−timestamp_tv32[0] 807 (5)

Next, the communication information circulating unit 313 calculates a score for determining the necessity of the optimization function for the session corresponding to the target session information (step S1110). A score calculation process will be described later with reference to FIG. 12. The communication information circulating unit 313 sets the calculated score in the score 918 of the analysis data 900. Thereafter, the communication information circulating unit 313 returns to step S1101, and repeatedly performs the same process on all pieces of the session information.

The score calculation process will be described with reference to FIG. 12.

The communication information circulating unit 313 calculates the score by using the retransmission rate and the RTT (step S1201). In the present example, the communication information circulating unit 313 performs the process from step S1201 to step S1204 on each of communication in the right direction and the communication in the left direction.

The communication information circulating unit 313 calculates the score by substituting the current_loss_rate [0] 913, the current_rtt_us[0] 915, and the current_rtt_us [1] 916 of the analysis data 900 into the following Equation (6). The communication information circulating unit 313 sets the calculated score in the score 918 of the analysis data 900.

score=a*(current_rtt_us[0] 915+current_rtt_us[1] 916)+b*current_loss_rate[0] 913 (6)

Here, a and b in Equation 6 are modifiable parameters, and for example, a is set to “0.001”, and b is set to “1”. If calculating the score by using Equation (6), the score value of a session having large communication delay and a large packet discard rate in a network. Therefore, the optimization function is preferentially applied to the session having a great score value.

Next, the communication information circulating unit 313 determines whether or not the number of ACK-completed bytes (last ack bytes [0] 905) is equal to or less than c (step S1202). Here, c is a changeable parameter. The process of step S1202 is a process of determining whether or not the communication amount after the start of communication is large.

When it is determined that the number of ACK-completed bytes is equal to or less than c, the communication information circulating unit 313 changes the score 918 to “0” (step S1204), and then the process proceeds to step S1205. In the case of a session having a small amount of communication after the start of communication, there is no need to apply the optimization function, and thus the determination using the score is not performed.

When it is determined that the number of ACK-completed bytes is greater than c, the communication information circulating unit 313 determines whether or not the current bandwidth (current_bw[0] 909) is equal to or less than d (step S1203). The process of step S1203 is a process of determining whether or not the current amount of communication is large.

When it is determined that the current bandwidth is equal to or less than d, the communication information circulating unit 313 changes the score 918 to “0” (step S1204), and then the process proceeds to step S1205. In the case of a session having a small amount of current communication, there is no need to apply the optimization function, and thus the determination using the score is not performed.

When it is determined that the current bandwidth is greater than d, the communication information circulating unit 313 calculates the score for the communication in the left direction.

In step S1201, the score is calculated through an equation using current_loss_rate[1] 914 instead of the current_loss_rate[0] 913 of Equation (6). The communication information circulating unit 313 adds the calculated score to the score 918.

In step S1202, it is determined whether or not the last_ack_bytes[1] 906 is equal to or less than c. Further, in step S1203 , it is determined whether or not the current_bw [1] 910 is equal to or less than d.

When controlling the communication device 100 that manages a set of communication in the right direction and communication in the left direction, it is possible to realize the effective control of a session by using the score taking account of two-way communication.

After the score for the two-way communication is calculated, the communication information circulating unit 313 determines whether or not the scores for all sessions are calculated (step S1205).

When it is determined that the scores for all sessions are not calculated, the communication information circulating unit 313 returns to step S1201, and performs the same process.

When it is determined that the scores for all sessions are calculated, the communication information circulating unit 313 determines the necessity of application of the optimization function for a session, based on the calculated score (step S1206). Thereafter, the communication information circulating unit 313 ends the process.

For example, when the score is less than a threshold, the communication information circulating unit 313 determines that it is not necessary to apply the optimization function for the session. As another determination method, the communication information circulating unit 313 selects sessions by the pre-defined number, in a descending order of a score, and determines that the selected session is a session to be applied with the optimization function.

In addition, the communication device control unit 312 may determine the necessity of the application of the optimization function for a session, based on the score.

The present example is not limited to a score calculation method. For example, the score may be calculated by using only one of a packet discard rate and a communication delay time. Further, the score may be calculated based on the communication amount, a port number, a packet length, an entropy of data, and the like, in addition to the packet discard rate and the communication delay time.

The communication information circulating unit 313 notifies the communication device control unit 312 of information on a session for which the optimization function is determined to be needed.

The communication device control unit 312 generates a control command to enable the optimization function for the session for which the optimization function is determined to be needed, based on the information notified from the communication information circulating unit 313, with reference to the session information stored in the communication information storage unit 314. The control command includes information for specifying a session, such as an IP address and a port number, and a control type instructing the enablement of the optimization function.

Further, the communication device control unit 312 generates a control command to disable the optimization function for another session. The control command includes information for specifying a session for which the optimization function is determined to be needed, and a control type instructing the disablement of the optimization function. In addition, when the disablement of the optimization function is instructed for a certain session, the control command includes the information for specifying the session for which the optimization function is determined not to be needed.

In addition, when using the score for each optimization function, the control command includes information for specifying the type of the optimization function.

The communication device control unit 312 transmits two pieces of control command to the communication device 100.

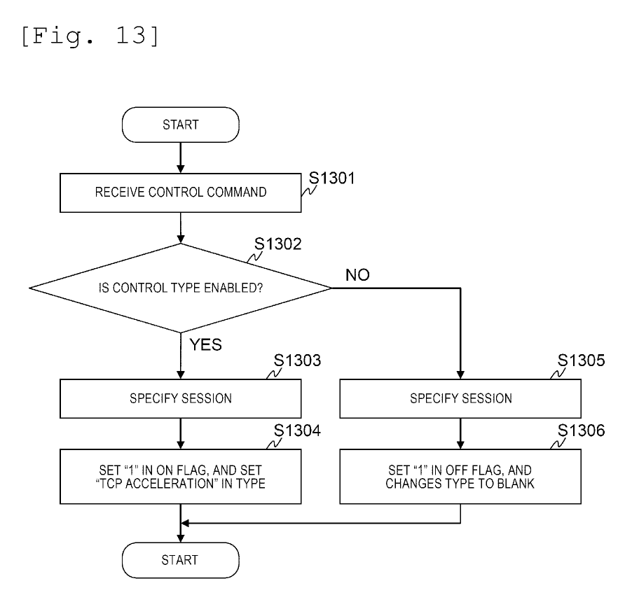

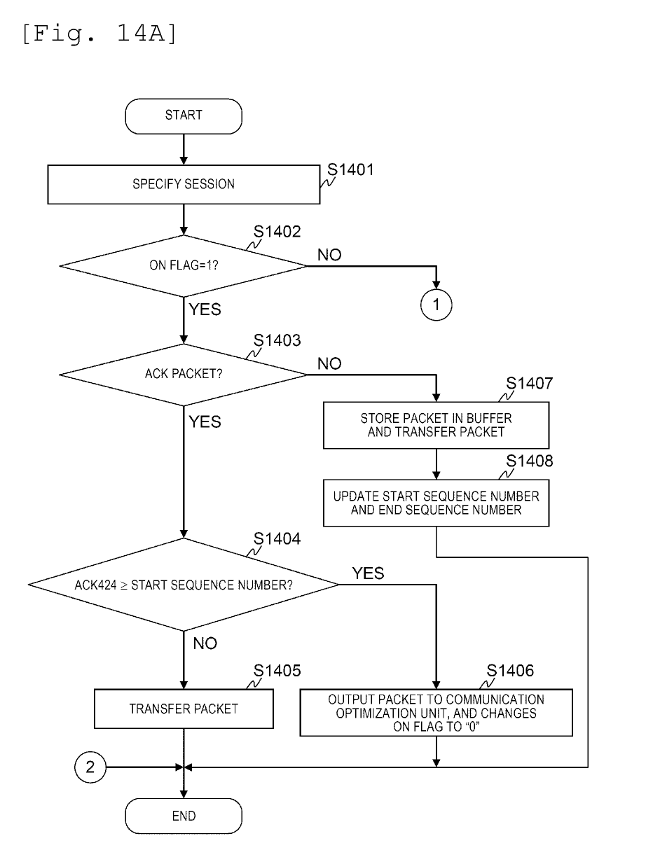

Next, the process performed by the communication device 100 will be described with reference FIGS. 13, 14A and 14B.

FIG. 13 is a flowchart illustrating a process that is executed when the connection management unit 212 of the communication device 100 of Example 1 receives a control command from the analyzing device 110.

When receiving the control command from the analyzing device 110 (step S1301), the connection management unit 212 starts a process described below.

The connection management unit 212 determines whether or not the control type included in the control command is the control type instructing the enablement of the optimization function (step S1302).

When it is determined that the control type included in the control command is the control type instructing the enablement of the optimization function, the connection management unit 212 specifies a session, based on the information for specifying a session included in the control command, with reference to the session management table 213 (step S1303).

Specifically, the connection management unit 212 searches for an entry in which the transmission source IP address 501, the transmission source port number 502, the transmission destination IP address 503, and the transmission destination port number 504 match the information included in the control command.

The connection management unit 212 sets “1” in the ON flag 507 of the specified session, and sets TCP acceleration in the type 509 (step S1304). Thereafter, the connection management unit 212 ends the process. The connection management unit 212 starts the monitoring of the ACK packet until the ON flag 507 is changed to “0”.

In step S1302, when it is determined that the control type included in the control command is the control type instructing the disablement of the optimization function, the connection management unit 212 specifies a session for which the optimization function is disabled, among sessions for which the optimization function is enabled at present (step S1305).

For example, the connection management unit 212 searches for a session for which TCP acceleration is set in the type 509 of the session management table 213. The connection management unit 212 specifies a session for which the optimization function is disabled, by comparing the information for specifying a session included in the control command with the information on the specified session.

The connection management unit 212 sets “1” in the OFF flag 508 of the specified session, and changes the type 509 to a blank (step S1306). Thereafter, the connection management unit 212 ends the process.

FIGS. 14A and 14B are flowcharts illustrating a process that is executed by the connection management unit 212 of the communication device 100 of Example 1.

When receiving a packet, the connection management unit 212 starts the process described below. The connection management unit 212 analyzes the received packet, and specifies a session through which the packet flows, using the session management table 213, based on the analysis result (step S1401).

Specifically, the connection management unit 212 searches for an entry in which the SIP 413, the src.port 421, the DIP 414, and the dst.port 422 respectively match the transmission source IP address 501, the transmission source port number 502, the transmission destination IP address 503, and the transmission destination port number 504.

The connection management unit 212 determines whether or not the ON flag 507 of the entry corresponding to the specified session is “1” (step S1402).

When it is determined that the ON flag 507 is “1”, the connection management unit 212 determines whether or not the received packet is the ACK packet (step S1403).

When it is determined that the received packet is the ACK packet, the connection management unit 212 determines whether or not the ACK 424 included in the ACK packet is equal to or greater than the start sequence number 505 of the entry corresponding to the specified session (step S1404).

When it is determined that the ACK424 included in the ACK packet is smaller than the start sequence number 505 of the entry corresponding to the specified session, the connection management unit 212 transfers the received ACK packet (step S1405). In other words, a normal transfer process is performed. In this case, the connection management unit 212 does not output the received packet to the communication optimization unit 211, but rather transfers a packet from the NIC 220 on the transmission side. Thereafter, the connection management unit 212 ends the process.

When it is determined that the ACK 424 included in the ACK packet is equal to or greater than the start sequence number 505 of the entry corresponding to the specified session, the connection management unit 212 determines that the optimization process is started, outputs the received packet to the communication optimization unit 211, and changes the ON flag 507 of the entry to “0” (step S1406). Thereafter, the connection management unit 212 ends the process. Thus, the connection management unit 212 can cause the communication optimization unit 211 to start the optimization process.

When it is determined that the received packet is not the ACK packet but rather is the data packet in step S1403, the connection management unit 212 stores the received packet in the buffer 214 and transfers the packet (step S1407). In this case, the connection management unit 212 does not output the received packet to the communication optimization unit 211, but rather transfers the packet from the NIC 220 on the transmission side.

When a data packet is received in the case where the ON flag 507 is “1”, the optimization process by the communication optimization unit 211 has not yet been started. Since the optimization function is applied to a session after receiving the ACK packet including a predetermined sequence number, the connection management unit 212 stores the received packet in the buffer 214. Thus, even before the optimization process by the communication optimization unit 211 is started, it is possible to accumulate the packet required for the optimization process in the buffer 214.

Next, the connection management unit 212 updates the start sequence number 505 and the end sequence number 506 of the entry corresponding to the specified session, based on the payload length of the received data packet and the SEQ 423 included in the packet (step S1408). In addition, the start sequence number 505 is updated to the value of the SEQ 423, only in the case of the data packet that is first received after the ON flag 507 becomes “1” . Further, the end sequence number 506 is updated to a value obtained by adding the SEQ 423 and the payload length. Thereafter, the connection management unit 212 ends the process.

When it is determined that the ON flag 507 of the entry corresponding to the specified session is “0” in step S1402, the connection management unit 212 determines whether or not the OFF flag 508 of the entry is “1” (step S1411).

When it is determined that the OFF flag 508 of the entry corresponding to the specified session is “1”, the connection management unit 212 determines whether or not the received packet is the ACK packet (step S1412).

When it is determined that the received packet is the ACK packet, the connection management unit 212 determines whether or not the ACK 424 included in the ACK packet is equal to or greater than the end sequence number 506 of the specified entry (step S1413).

When it is determined that the ACK 424 of the ACK packet is smaller than the end sequence number 506 of the specified entry, the connection management unit 212 deletes packets for which the ACK 424 of the packet corresponds to the ACK 424 of the received packet or is equal to or less than the ACK 424, among the packets stored in the buffer 214, from the buffer 214 (step S1414). Thereafter, the connection management unit 212 ends the process.

When it is determined that the ACK 424 of the ACK packet is equal to or greater than the end sequence number 506 of the specified entry, the connection management unit 212 determines that the optimization function on the specified session has been ended, transfers the received packet, and changes the OFF flag 508 of the entry to “0” (step S1415). In this case, the connection management unit 212 does not output the received packet to the communication optimization unit 211, but rather transfers a packet from the NIC 220 on the transmission side. Thereafter, the connection management unit 212 ends the process. Thus, the connection management unit 212 can cause the communication optimization unit 211 to end the optimization process.

When it is determined that the received packet is the data packet in step S1412, the connection management unit 212 transfers the received packet (step S1417). In this case, the connection management unit 212 does not output the received packet to the communication optimization unit 211, but rather transfers a packet from the NIC 220 on the transmission side. Thereafter, the connection management unit 212 ends the process.

When it is determined that the OFF flag 508 of the entry corresponding to the specified session is “0” in step S1411, the connection management unit 212 determines whether or not the optimization function is applied to the session (step S1416).

Specifically, the connection management unit 212 determines whether or not the type 509 of the entry corresponding to the session is blank. When the type 509 is blank, the connection management unit 212 determines that the optimization function is applied to the session.

When it is determined that the optimization function is not applied to the specified session, the connection management unit 212 transfers the received packet (step S1417). Thereafter, the connection management unit 212 ends the process.

When it is determined that the optimization function is applied to the specified session, the connection management unit 212 outputs the received packet to the communication optimization unit 211 (step S1418). Thereafter, the connection management unit 212 ends the process.

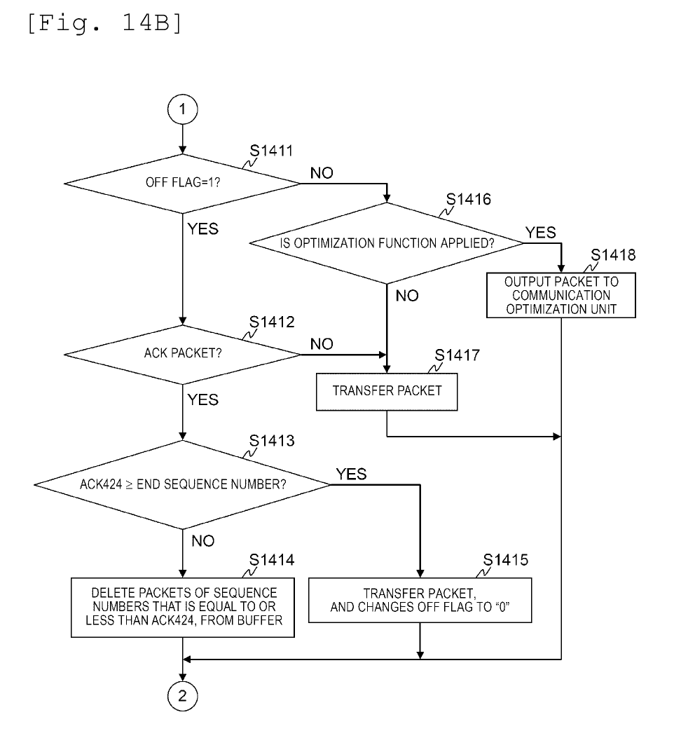

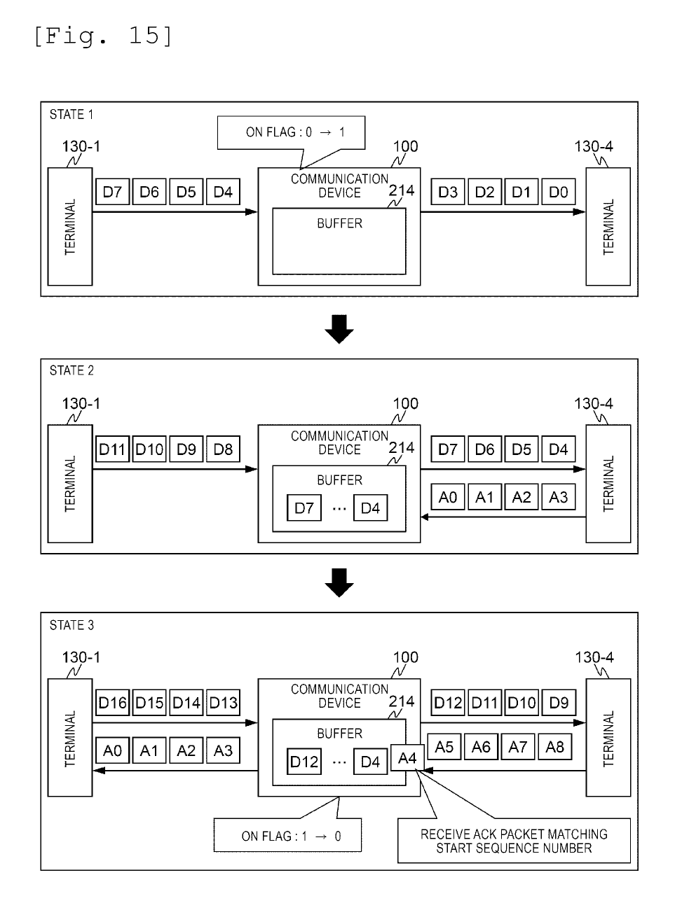

Next, the control contents of the communication device 100 will be described using a specific example. FIG. 15 is an explanatory diagram illustrating state transition until the communication device 100 of Example 1 starts an optimization process. FIG. 16 is an explanatory diagram illustrating state transition until the communication device 100 of Example 1 ends the optimization process. In the following description, it is assumed that a session is established between the terminal 130-1 and the terminal 130-4.

In state 1, it is assumed that “1” is set in the ON flag 507, after the communication device 100 transfers data packets D0 to D3 that are received from the terminal 130-1, to the terminal 130-4. At this time, the optimization process is not started for the session.

In addition, since the ON flag 507 and the OFF flag 508 are “0” and the optimization function is not applied to the session at a time when the communication device 100 receives the data packets D0 to D3, the data packets D0 to D3 are transferred to the transmission destination terminal 130-4 (step S1417).

In state 1, it is assumed that the communication device 100 receives data packets D4 to D7 addressed to the terminal 130-4 from the terminal 130-1, after “1’ is set in the ON flag 507.

In state 2, when receiving the data packets D4 to D7, the communication device 100 determines that the ON flag 507 is “1” (YES in step S1402), and determines that the received packet is a data packet (NO in step S1403). Therefore, the communication device 100 stores the received data packets D4 to D7 in the buffer 214, and transfers the data packets D4 to D7 to the terminal 130-4 (step S1407). Further, the communication device 100 sets the SEQ 423 of the data packet D4 in the start sequence number 505, and sets the SEQ 423 of the data packet D7 in the end sequence number 506 (step S1408).

Further, in state 2, the terminal 130-1 transmits data packets D8 to D11 addressed to the terminal 130-4, and the terminal 130-4 transmits ACK packets A0 to A3 addressed to the terminal 130-1.

When receiving the data packets D8 to D11, the communication device 100 determines that the ON flag 507 is “1” (YES in step S1402), and determines that the received packet is a data packet (NO in step S1403). Therefore, the communication device 100 stores the received data packets D8 to D11 in the buffer 214, and transfers the data packets D8 to D11 to the terminal 130-4 (step S1407). Further, the communication device 100 sets the SEQ 423 of the data packet D11 in the end sequence number 506 (step S1408).

In state 3, it is assumed that the communication device 100 transfers the data packets D9 to D12 received from the terminal 130-1, to the terminal 130-4, the terminal 130-1 transmits data packets D13 to D16 addressed to the terminal 130-4, and the terminal 130-4 transmits ACK packets A4 to A8 addressed to the terminal 130-1.

When the receiving ACK packets AO to A3, the communication device 100 determines that the ON flag 507 is “1” (YES in step S1402), and determines that the received packet is an ACK packet (YES in step S1403). Further, the communication device 100 determines that the ACK 424 of the ACK packet A3 is smaller than the start sequence number 505 (NO in step S1404). Therefore, the communication device 100 transfers the received ACK packets A0 to A3 to the terminal 130-1 (step S1405).

When receiving the ACK packet A4, the communication device 100 determines that the ACK 424 of the ACK packet A3 is equal to or greater than the start sequence number 505 (YES in step S1404). Therefore, the communication device 100 changes the ON flag 507 to “0”, and starts the optimization process.

In state 4, it is assumed that “1’ is set in the OFF flag 508, after the communication device 100 stores the data packets D0 to D7 received from the terminal 130-1 in the buffer 214, and transfers the packets to the terminal 130-4. At this time, the optimization function for the session is not ended. Further, the SEQ 423 of the data packet D0 is stored in the start sequence number 505 of the entry corresponding to the session, and the SEQ 423 of the data packet D7 is stored in the end sequence number 506.

In state 4, the terminal 130-4 transmits the ACK packets A0 to A3 addressed to the terminal 130-1. Further, the terminal 130-1 transmits the data packets D8 to D11 addressed to the terminal 130-4.

In state 5, when receiving the data packets D8 to D11, the communication device 100 determines that the OFF flag 508 is “1” (YES in step S1411), and determines that the received packet is a data packet (NO in step S1412). Therefore, the communication device 100 does not store the received data packets D8 to Dll in the buffer 214, but rather transfers the packets to the terminal 130-4 (step S1417).

In state 5, when receiving the ACK packets A0 to A3, the communication device 100 determines that the OFF flag 508 is “1” (YES in step S1411), and determines that the received packet is an ACK packet (YES in step S1412). Further, the communication device 100 determines that the ACK 424 of the ACK packet A3 is smaller than the end sequence number 506 (NO in step S1413). Therefore, the communication device 100 deletes the data packets A0 to A4 stored in the buffer 214 (step 51414).

In state 5, the terminal 130-1 transmits the data packets D12 to D15 addressed to the terminal 130-4. Further, the terminal 130-4 transmits the ACK packets A4 to A7 addressed to the terminal 130-1.

In state 6, when receiving the data packets D12 to D15, the communication device 100 determines that the OFF flag 508 is “1” (YES in step S1411), and determines that the received packet is a data packet (NO in step S1412). Therefore, the communication device 100 does not store the received data packets D12 to D15 in the buffer 214, but rather transfers the packets to the terminal 130-4 (step S1417).

In state 6, receiving the ACK packet A7, the communication device 100 determines that the ACK 424 of the ACK packet A3 is equal to or greater than the end sequence number 506 (YES in step S1413). Therefore, the communication device 100 changes the OFF flag 508 to “0”, and ends the optimization process. Thereafter, the communication device 100 performs a normal transfer process.

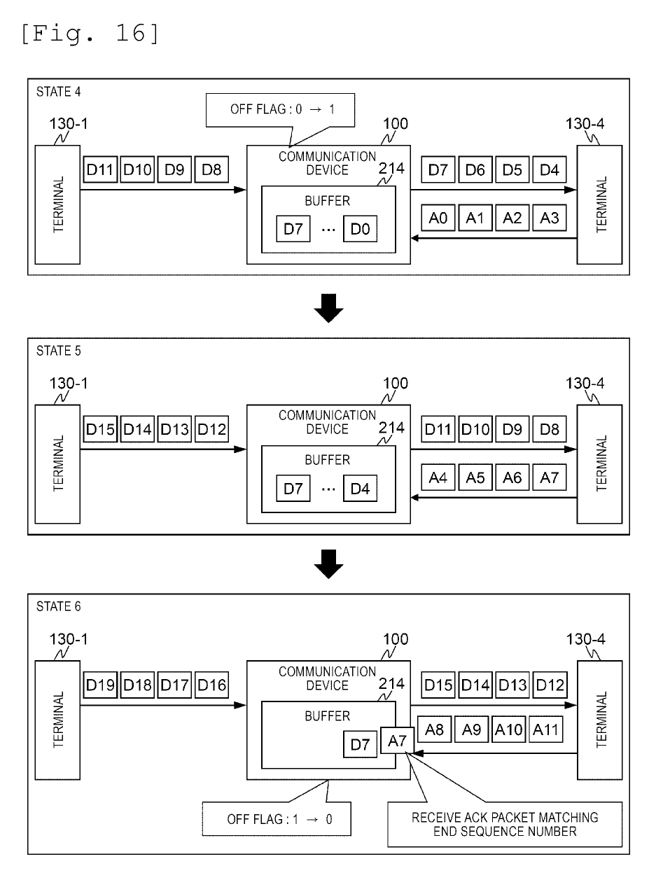

FIG. 17 is an explanatory diagram illustrating a state of a session of a communication line of Example 1. It is assumed that the number of session to which the communication device 100 can apply the optimization function is “4”.

In the example of FIG. 17, the communication device 100 applies the optimization function for four sessions. The analyzing device 110 determines that the optimization function is unrequired for two sessions, and selects two new sessions applied with the optimization function.

When receiving a control command to enable the optimization function and the control command to disable the optimization function from the analyzing device, the communication device 100 changes a session to be applied with the optimization function, as illustrated in FIG. 17. This allows effective utilization of the optimization function included in the communication device 100. Further, since it is possible to dynamically change the session to be applied with the optimization function, thereby providing high quality communication.

Further, the communication device 100 can properly manage the start timing or the end timing of the optimization process so as to enable the retransmission or the like of data packets in the TCP communication.

In addition, the present invention is not limited to the embodiments described above, and includes various modification examples. Further, for example, the embodiments described above are described in detail regarding configurations in order to illustrate and clarify the invention, and are not intended to be limited to necessarily include all of the configurations described. Further, a part of the configuration of each embodiment can be added to, deleted from, or replaced with the other configurations.

Further, the respective configurations, functions, processors, processing means or the like described above may be realized by hardware, for example, of which some or all are designed into an integrated circuit. The invention can also be realized by program codes of software for realizing the functions of the embodiments. In this case, a storage medium storing the program codes is provided to a computer, and a CPU included in the computer reads the program codes stored in the storage medium. In this case, the program codes read from the storage medium realize the functions of the embodiments described above, and the program codes and the storage medium storing the program codes constitute the present invention. As a storage medium for supplying such program codes, for example, a flexible disk, a CD-ROM, a DVD-ROM, a hard disk, a solid state drive (SSD), an optical disk, a magneto-optical disk, a CD-R, a magnetic tape, a nonvolatile memory card, a ROM, and the like are used.

Further, the program codes that implement the functions described in the present example can be implemented in a wide range of programs or scripting languages such as, for example, assembler, C/C++, perl, Shell, PHP, and Java (registered trademark).

Further, the software program codes that implement the functions of the embodiments are distributed through a network, and stored in storage means such as a hard disk or a memory of a computer, or a storage medium such as a CD-RW or a CD-R, and the CPU included in the computer may read and execute the program codes stored in the storage means or the storage medium.

In the above embodiment, the control lines and the information lines are illustrated as being necessary for explanation, and all control lines and information lines are not necessarily illustrated on products. All of the configurations may be connected to each other.

### REFERENCE SIGNS LIST

100 COMMUNICATION DEVICE

110 ANALYZING DEVICE

120 TRANSFER DEVICE

130 TERMINAL

140 NETWORK

200 ARITHMETIC DEVICE

210 MAIN STORAGE DEVICE

211 COMMUNICATION OPTIMIZATION UNIT

212 CONNECTION MANAGEMENT UNIT

213 SESSION MANAGEMENT TABLE

214 BUFFER

220 NIC

230 SYSTEM BUS

300 ARITHMETIC DEVICE

310 MAIN STORAGE DEVICE

311 RECEPTION PROCESSING UNIT

312 COMMUNICATION DEVICE CONTROL UNIT

313 COMMUNICATION INFORMATION CIRCULATING UNIT

314 COMMUNICATION INFORMATION STORAGE UNIT

320 NIC

330 SYSTEM BUS

600 NIC

610 PORT MIRRORING FUNCTION UNIT

700 SESSION DATA

800 CAPTURE DATA

900 ANALYSIS DATA

1801 SYN PACKET

1802 SYNACK PACKET

1803 ACK PACKET

1805 FIN PACKET

1806 FIN ACK PACKET

1807 ACK PACKET

1900 COMMUNICATION DEVICE

1910 TERMINAL

1. A network system comprising:
a plurality of communication devices, each of which controls communication between terminals connected through a network; and
an analyzing device that analyzes a packet flowing through the network,
wherein the analyzing device includes
an analyzing unit that analyzes the packet flowing through the network, and determines necessity of a communication optimization function that the communication device has, for each communication, based on the analysis result, and
a control unit that generates a control command of the communication device based on the determination result, and transmits the control command to the communication device, and
wherein the communication device includes
an optimization unit that performs an optimization process for the communication for which the communication optimization function is determined to be required, and
a connection management unit that controls a transmission and reception process of the packet, and changes the communication to be applied with the communication optimization function, based on the control command.

2. The network system according to claim 1,
wherein the communication device includes a buffer that temporarily stores a data packet that is transmitted through the communication, and
wherein the connection management unit
stores a data packet in the buffer, when receiving the data packet transmitted through first communication, after receiving the control command to instruct enablement of the communication optimization function for the first communication, and
causes the optimization unit to start an optimization process for the first communication, when receiving a response packet corresponding to a data packet stored in the buffer.

3. The network system according to claim 2,
wherein the connection management unit
transmits a data packet to a transmission destination terminal, when receiving the data packet transmitted through second communication, after receiving the control command to instruct disablement of the communication optimization function applied to the second communication, and
causes the optimization unit to end an optimization process for the second communication, when receiving a response packet corresponding to a data packet stored in the buffer and transmitted through the second transmission.

4. The network system according to claim 3,
wherein the connection management unit
manages an identification number of the data packet stored in the buffer, and
compares the identification number of the data packet stored in the buffer with an identification number included in the response packet and determines whether or not the response packet is a response packet for the data packet stored in the buffer.

5. The network system according to claim 3,
wherein the connection management unit deletes the data packet corresponding to the received response packet from among data packets stored in the buffer, when receiving a response packet, after receiving the control command to instruct disablement of the communication optimization function applied to the second communication.

6. A control method of a network system that includes a plurality of communication devices of which each controls communication between terminals which are connected through a network, and an analyzing device that analyzes a packet flowing through the network, the control method of a network system comprising:
a first step of the analyzing device analyzing a packet flowing through the network, and determining necessity of a communication optimization function that the communication device has, for each communication, based on the analysis result,
a second step of the analyzing device generating a control command of the communication device based on the determination result, and transmitting the control command to the communication device,
a third step of the communication device controlling a transmission and reception process of a packet,
a fourth step of the communication device performing an optimization process for the communication for which the communication optimization function is determined to be required, and
a fifth step of the communication device changing the communication to be applied with the communication optimization function based on the control command.

7. The control method of a network system according to claim 6,
wherein the communication device includes a buffer that temporarily stores a data packet that is transmitted by the communication, and
wherein the fifth step includes
a sixth step of storing the data packet in the buffer, when receiving the data packet transmitted through first communication, after receiving the control command to instruct enablement of the communication optimization function for the first communication, and
a seventh step of starting an optimization process for the first communication, when receiving a response packet corresponding to a data packet stored in the buffer.

8. The control method of a network system according to claim 7,
wherein the fifth step includes
an eighth step of transmitting the data packet to a transmission destination terminal, when receiving the data packet transmitted through second communication, after receiving a control command to instruct disablement of the communication optimization function applied to the second communication, and
a ninth step of ending an optimization process for the second communication, when receiving a response packet for a data packet stored in the buffer and transmitted through the second transmission.

9. The control method of a network system according to claim 8,
wherein the communication device manages an identification number of the data packet stored in the buffer, and
wherein the seventh step and the ninth step include a step of comparing the identification number of the data packet stored in the buffer with an identification number included in the response packet and determines whether or not the response packet is a response packet corresponding to the data packet stored in the buffer.

10. The control method of a network system according to claim 8,
wherein the ninth step includes a step of deleting a data packet corresponding to the received response packet, from data packets stored in the buffer when receiving the response packet.

11. A communication device which controls communication between terminals which are connected through a network, the communication device comprising:
an optimization unit that performs an optimization process based on a communication optimization function for specific communication; and
a connection management unit that controls a transmission and reception process of a packet, and
wherein the connection management unit
specifies target communication when receiving a control command to change communication to be applied with the communication optimization function, and
changes application of the communication optimization function to the specified communication.

12. The communication device according to claim 11, further comprising:
a buffer that temporarily stores a data packet that is transmitted by the communication,
wherein the connection management unit
stores a data packet in the buffer, when receiving the data packet transmitted through first communication, after receiving the control command to instruct enablement of the communication optimization function for the first communication, and
causes the optimization unit to start an optimization process for the first communication, when receiving a response packet corresponding to a data packet stored in the buffer.

13. The communication device according to claim 12,
wherein the connection management unit
transmits a data packet to a transmission destination terminal, when receiving the data packet transmitted through second communication, after receiving the control command to instruct disablement of the communication optimization function applied to the second communication, and
causes the optimization unit to end an optimization process for the second communication, when receiving a response packet corresponding to a data packet stored in the buffer and transmitted through the second transmission.

14. The communication device according to claim 13,
wherein the connection management unit
manages an identification number of the data packet stored in the buffer, and
compares the identification number of the data packet stored in the buffer with an identification number included in the response packet and determines whether or not the response packet is a response packet for the data packet stored in the buffer.

15. The communication device according to claim 13,
wherein the optimization unit deletes a data packet corresponding to the received response packet, from data packets stored in the buffer, when receiving a response packet, after receiving the control command to instruct disablement of the communication optimization function applied to the second communication.

16. A program implemented in a communication device which controls communication between terminals connected through a network, the program causing the communication device to execute steps of
specifying target communication, when receiving a control command to change communication to be applied with a communication optimization function,
changing application of the communication optimization function to the specified communication, and
executing an optimization process based on the communication optimization function for certain communication.
